(19) United States
(12) Patent Application Publication
(10) Pub. No.: US 2024/0331288 A1
(43) Pub. Date: Oct. 3, 2024

(54) MULTIHEAD DEEP LEARNING MODEL FOR OBJECTS IN 3D SPACE

(71) Applicant: Rivian IP Holdings, LLC, Plymouth, MI (US)

(72) Inventors: Vikram Vijayanbabu Appia, San Jose, CA (US); Vishwas Venkatachalapathy, Newark, CA (US); Akshay Arvind Velankar, San Jose, CA (US); Amey Dilip Pawar, Sunnyvale, CA (US)

(21) Appl. No.: 18/129,172

(22) Filed: Mar. 31, 2023

(51) Int. Cl. G06T 17/05; G06T 7/10; G06T 19/20

(52) U.S. Cl. CPC G06T 17/05; G06T 7/10; G06T 19/20; G06T 2207/30252; G06T 2210/12

(57) ABSTRACT

Systems and methods are presented herein for generating a three-dimensional model based on data from one or more two-dimensional images to identify a traversable space for a vehicle and objects surrounding the vehicle. A bounding area is generated around an object identified in a two-dimensional image captured by one or more sensors of a vehicle. Semantic segmentation of the two-dimensional image is performed based on the bounding area to differentiate between the object and a traversable space. The three-dimensional model of an environment comprised of the object and the traversable space is generated based on the semantic segmentation. The three-dimensional model is used for one or more of processing or transmitting instructions useable by one or more driver assistance features of the vehicle.

### INTRODUCTION

The present disclosure is directed to systems and methods for generating a three-dimensional model based on data from one or more two-dimensional images to identify objects surrounding a vehicle and traversable space for the vehicle.

### SUMMARY

The disclosure is generally directed to generating a three-dimensional (3D) model of an environment around a vehicle based on one or more two-dimensional (2D) images (e.g., one or more frames of a video), and more particularly, to a vehicle that uses a monocular camera arranged to capture images or video external to the vehicle and processing the captured images or video to generate a 3D model of the environment around the vehicle and objects occupying the environment. For example, a camera may be arranged on a front bumper of the vehicle or along a side element of the vehicle, such as a side mirror facing rearward. The camera may be arranged in a manner where it is the only sensor arranged to capture data corresponding a predefined area around the vehicle, based on the range of motion of the camera or the field of view of the lens of the camera. It is advantageous to be able to characterize a 3D space and objects therein around the vehicle based only on the data received from a monocular camera (e.g., a camera arranged as described herein) to minimize processing performed by the vehicle while also maximizing accuracy of modeling of the 3D environment around the vehicles and objects within the 3D environment. This reduces the need for stereo camera setups and additional sensors providing significant amounts of data for a vehicle to characterize the environment around the vehicle and objects therein.

In some example embodiments, the disclosure is directed to at least one of a system configured to perform a method, a non-transitory computer readable medium (e.g., a software or software related application) which causes a system to perform a method, and a method for generating a 3D model of an environment around a vehicle and objects within the environment based on processing of pixels in a 2D image. The method comprises capturing one or more 2D images (e.g., frames in a video) based on one or more sensors arranged in or on a vehicle assembly to characterize at least a portion of an environment around the vehicle. A bounding area (e.g., a bounding box) is generated around an object identified in the image. Semantic segmentation of the image is performed to differentiate between the object and a traversable space. A 3D model of an environment comprised of the object and the traversable space is generated.

In some embodiments, the 3D model generated involves multi-head deep learning such that the 2D image is processed through multiple models in order to differentiate between objects, traversable space, and also provide values characterizing relative motion between identified objects, the traversable space, and the vehicle being driven. The multi-head deep learning may incorporate multiple levels of processing of a same 2D image (e.g., first identifying objects, then identifying traversable space, then characterizing motion of the identified objects, and then generating a 3D model with legible labels for user viewing). Each form of processing of the 2D image to generate the 3D model may be performing contemporaneously or in a progressive manner. The generated 3D model may be used as part of one or more of driver assistance features of the vehicle such self-driving vehicle systems, advanced display vehicle systems such as touch screens and other heads up displays for driver interpretation, vehicle proximity warnings, lane change features, or any vehicle feature requiring detection of objects and characterization of objects approaching a vehicle or around the vehicle.

These techniques provide improvements to some existing approaches by reducing the number of sensors (e.g., a network of cameras or one or more monocular cameras) required to collected data in order to generate a 3D model of an environment around the vehicle. In particular, this approach does not rely on or require multiple inputs corresponding to a single object in order to determine what the object is, where the object is located, and a trajectory along which the object is headed (e.g., relative to the vehicle). Thus, a reduction in processing and time required to transmit instructions to various modules or subsystems of the vehicle (e.g., instructions to cause the vehicle to stop, turn, or otherwise modify speed or trajectory by actuating or activating one or more vehicle modules or subsystems) is enabled, thereby increasing vehicle responsiveness to inputs from the environment around the vehicle while decreasing the required processing power and power consumption during operation of the vehicle. Additionally, the approaches disclosed herein provide a means to update calibrations and error computations stored in the vehicle to improve object detection thereby providing a means for adequate training of the vehicle system (e.g., based on the addition of new or focused data to improve the resolution or confidence in object detection, thereby improving vehicle system responsiveness to various objects and inputs).

In some embodiments, the method further comprises modifying the two-dimensional image to differentiate between the object and the traversable space by incorporating one or more of a change in a color of pixels comprising one or more of the object or the traversable space or a label corresponding to a predefined classification of pixels comprising one or more of the object or the traversable space. Values are assigned to pixels corresponding to the object, wherein the values correspond to one or more of a heading, a depth within a three-dimensional space, or a regression value.

In some embodiments, the three-dimensional model is generated for display. The three-dimensional model comprises a three-dimensional bounding area around one or more of the object or the traversable space. The three-dimensional bounding area may modify a display of one or more of the object or the traversable space to include one or more of a color-based demarcation or a text label.

In some embodiments, the bounding area is generated in response to identifying a predefined object in the two-dimensional image. The predefined object may be a vehicle, a pedestrian, a structure, a driving lane indicator, or a solid object impeding travel along a trajectory from a current vehicle position. The three-dimensional model comprises a characterization of movement of the object relative to the vehicle and the traversable space based on one or more values assigned to pixels corresponding to the object in the two dimensional image, wherein the one or more values correspond to one or more of a heading, a depth within a three-dimensional space around the vehicle, or a regression value.

In some embodiments, the bounding area is a second bounding area, wherein the two-dimensional image is a second two-dimensional image. Generating the second bounding area may comprises generating a first bounding area around an object for a first two-dimensional image captured by a first monocular camera, processing data corresponding to pixels within the first bounding area to generate object characterization data, and generating the second bounding area around an object identified in the second two-dimensional image captured by a second monocular camera based on the object characterization data.

In some embodiments, the disclosure is directed to a system comprising a monocular camera, a vehicle body, and processing circuitry, communicatively coupled to the monocular camera and the vehicle body, configured to perform one or more elements or steps of the methods disclosed herein. In some embodiments, the disclosure is directed to a non-transitory computer readable medium comprising computer readable instructions which, when processed by processing circuitry, causes the processing circuitry to perform one or more elements or steps of the methods disclosed herein.

### BRIEF DESCRIPTIONS OF THE DRAWINGS

The above and other objects and advantages of the disclosure may be apparent upon consideration of the following detailed description, taken in conjunction with the accompanying drawings, in which:

FIG. 1 depicts four examples of different forms of processing of a 2D image to identify an object near a vehicle and a space traversable by a vehicle that captured the 2D image, in accordance with some embodiments of the disclosure;

FIG. 2 depicts an illustrative scenario where a vehicle is configured to capture one or more 2D images of an environment around the vehicle to generate a 3D model of the environment around the vehicle, in accordance with some embodiments of the disclosure;

FIG. 3 depicts a monocular camera with different ranges of views for capturing 2D images, in accordance with some embodiments of the disclosure;

FIG. 4 depicts an illustrative process for processing a 2D image to identify an object near a vehicle and a space traversable by a vehicle that captured the 2D image, in accordance with some embodiments of the disclosure;

FIG. 5 is a block diagram of an example process for generating a 3D model based on a 2D image, in accordance with some embodiments of the disclosure;

FIG. 6 depicts a pair of example 2D images, with example confidence factors associated with the objects detected in the images, which is used to train a neural network of a vehicle for subsequent object detection, in accordance with some embodiments of the disclosure;

FIG. 7 is a block diagram of an example process for updating a method of processing of data to generate a 3D model based on a 2D image, in accordance with some embodiments of the disclosure;

FIG. 8 is an example vehicle system configured to generate a 3D model based on a 2D image, in accordance with some embodiments of the disclosure; and

FIG. 9 depicts an illustrative example of a pair of vehicle displays generating a 3D model for display, in accordance with some embodiments of the disclosure.

### DETAILED DESCRIPTION

Methods and systems are provided herein for generating a three-dimensional model based on data from one or more two-dimensional images to identify objects surrounding a vehicle and traversable space for the vehicle.

The methods and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (RAM), etc.

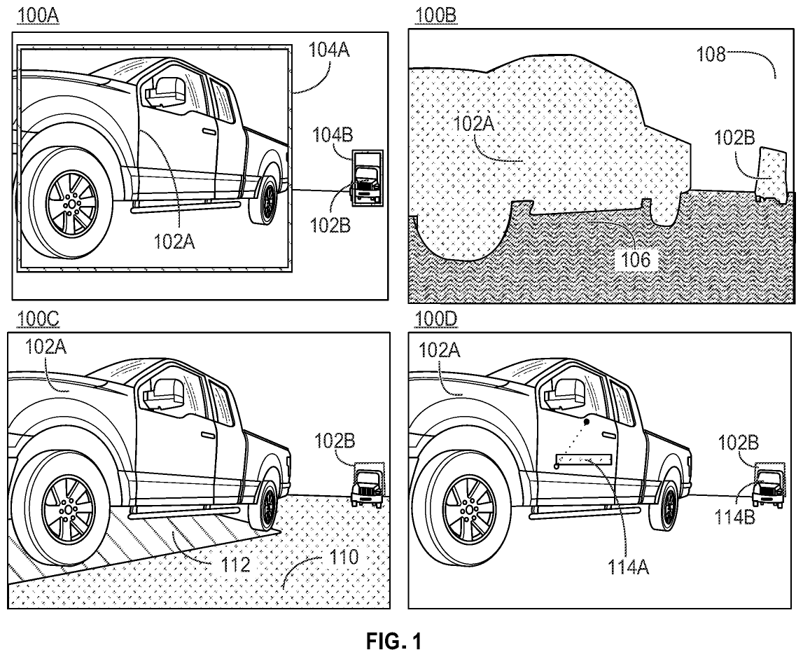

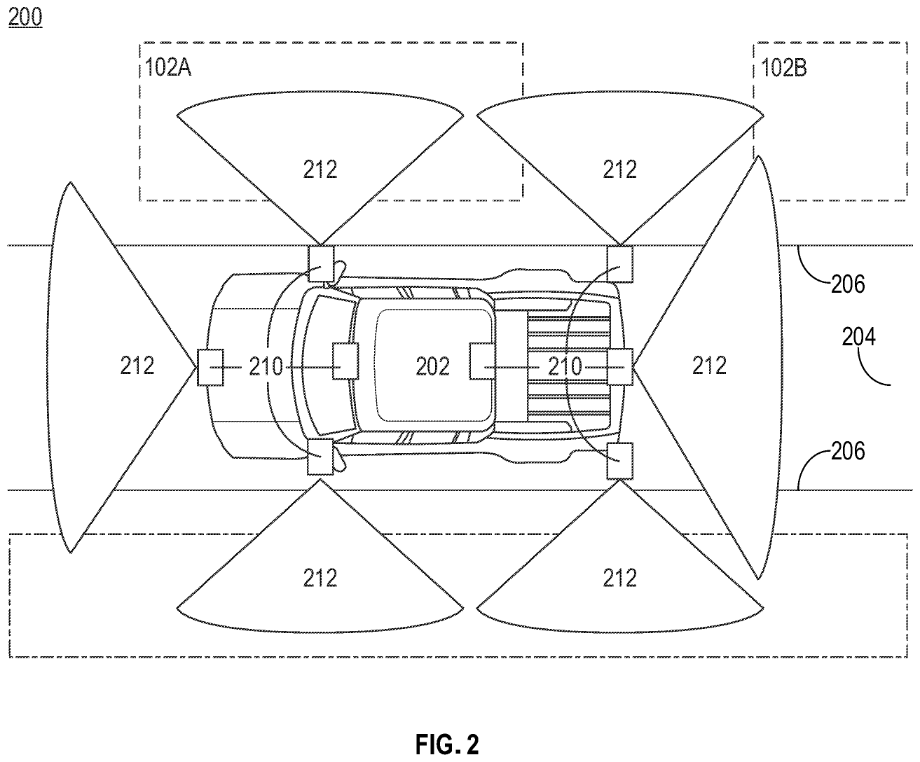

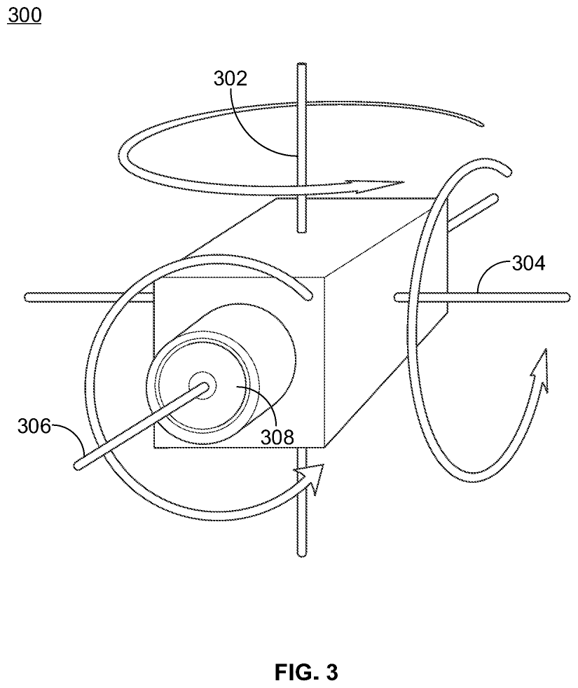

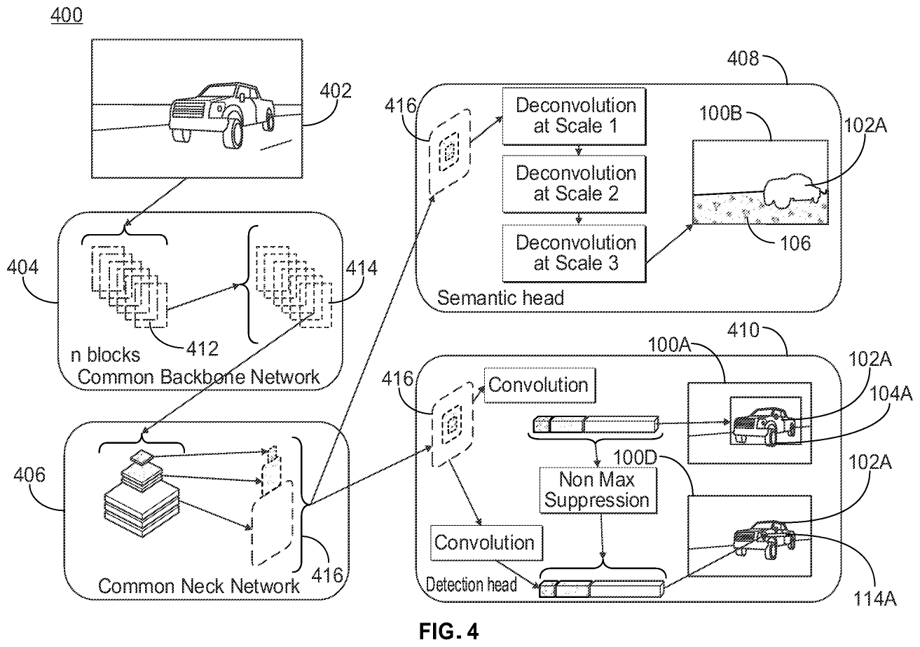

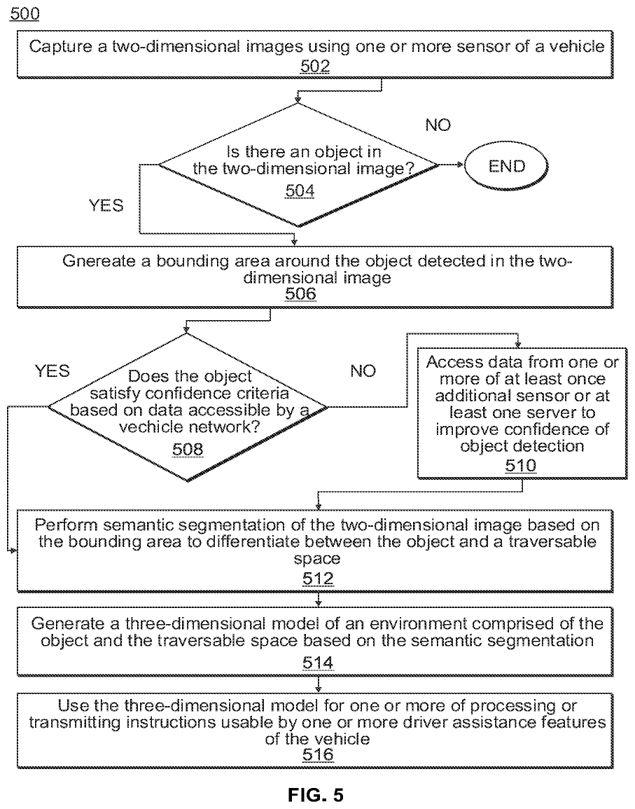

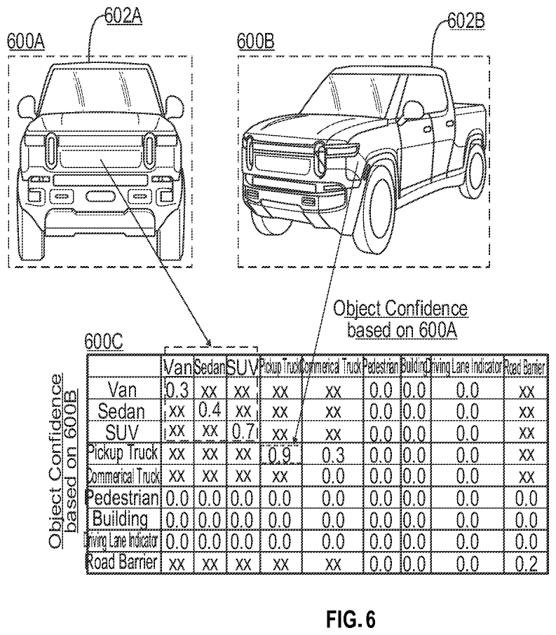

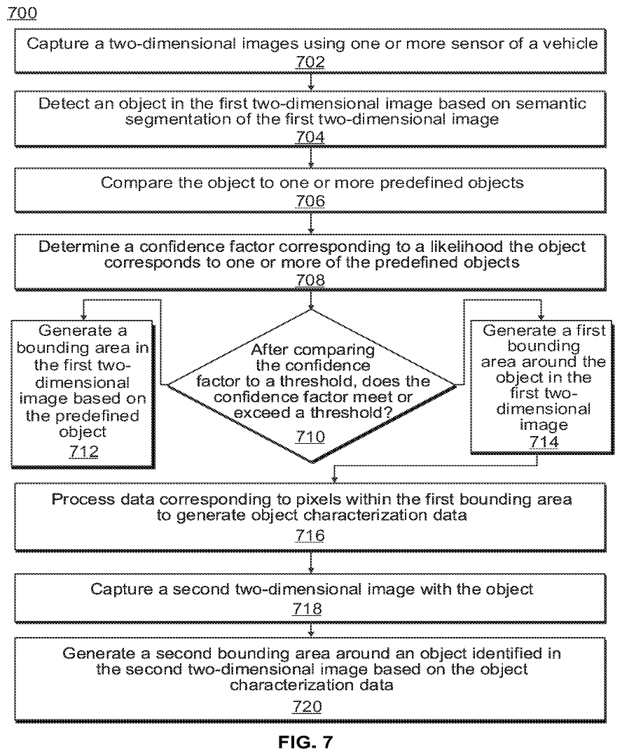

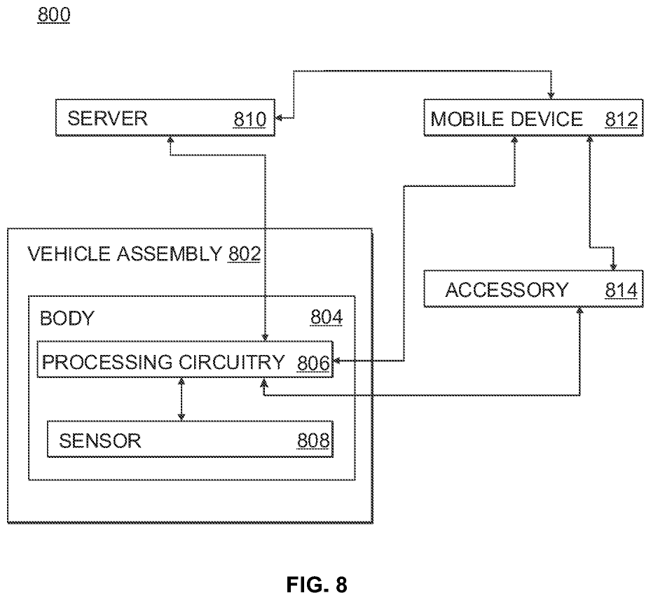

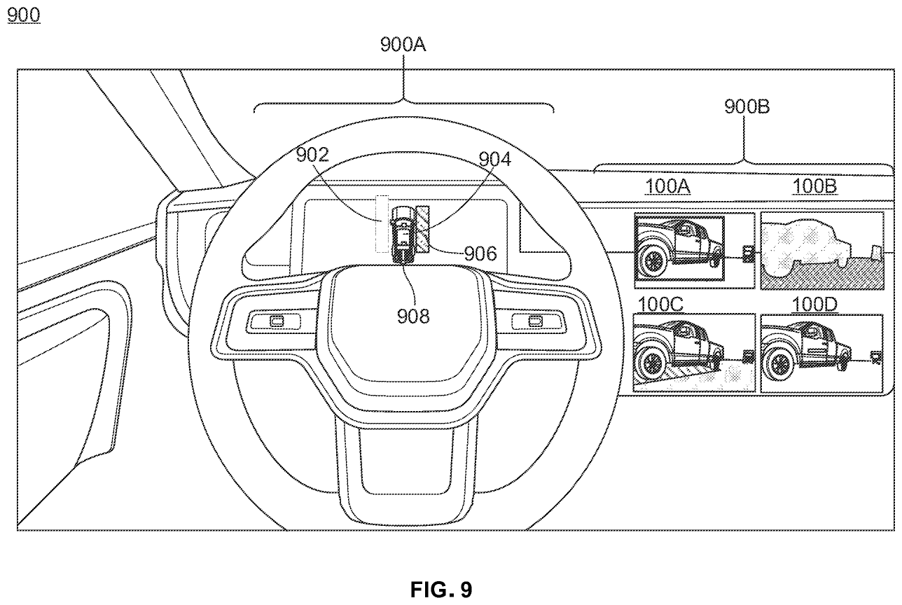

FIG. 1 depicts processed images 100A, 100B, 100C, and 100D, in accordance with some embodiments of the disclosure. Each of processed images 100A-100D are based on a 2D image captured by a sensor of a vehicle (e.g., a monocular camera of vehicle system 800 of FIG. 8). Processed images 100A-100D may be generated in a sequential order (e.g., processed image 100A is generated first and processed image 100D is generated last), contemporaneously (e.g., all four are generated at a same time), or in any order (e.g., one or more of processed images 100A-100D are generated first, then the remaining processed images are generated subsequently). One or more of processed images 100A-100D may be generated based on one or more of object detection scenario 200 of FIG. 2, using monocular camera 300 of FIG. 3, process 400 of FIG. 4, process 500 of FIG. 5, object detection corresponding to FIG. 6, process 700 of FIG. 7, using one or more components of vehicle system 800 of FIG. 8, or one or more of processed images 100A-100D may be generated for display as shown in FIG. 9.

Processed image 100A is a 2D image captured by one or more sensors (e.g., a camera) on a vehicle. The 2D image may be captured by a monocular camera. Alternatively, a stereo camera setup may be used. The 2D image is processed by processing circuitry in order to identify the contents of the image to support or assist one or more driver assistance features of the vehicle by identifying one or more object, non-traversable space, and traversable space. The driver assistance features may include one or more of lane departure warnings, driver assist, automated driving, automated braking, or navigation. Additional driver assistance features that may be configured to process information from the 2D image or generated based on processing of the 2D image include one or more of self-driving vehicle systems, advanced display vehicle systems such as touch screens and other heads up displays for driver interpretation, vehicle proximity warnings, lane change features, or any vehicle feature requiring detection of objects and characterization of objects approaching a vehicle or around the vehicle. Bounding areas 104A and 104B are generated around objects identified in the two-dimensional image, resulting in processed image 100A. Bounding areas 104A and 104B are generated in response to identifying predefined objects 102A and 102B in the two-dimensional image. Predefined object 102A is depicted as a passenger truck and predefined object 102B is depicted as a commercial truck. The objects around which a bounding area is generated may be one or more of a vehicle, a pedestrian, a structure, a driving lane indicator, or a solid object impeding travel along a trajectory from a current vehicle position. The objects are identified based on the characteristics of pixels within the 2D image that yields processed image 200A.

A library of predefined images and confidence factors may be utilized to determine whether objects captured in the 2D image correspond to known objects (e.g., as described in reference to FIG. 6). In some embodiments, an object may be identified that does not align with the library of predefined images and fails to yield a confidence factor to confirm the object. In response to not being able to identify the object, one or more servers storing object data communicably coupled to the vehicle which captured the 2D image may be caused to transmit additional data to the vehicle, or additional sensors may be activated to capture additional data to characterize the object. The additional data may be used to update the object library for future object identification (e.g., for training the vehicle neural network to identify new objects and improve characterizations thereby based on 2D image data).

Processed image 100B may be generated based on processed image 100A or based on the original 2D image. Processed image 100B is generated by performing semantic segmentation of the 2D image based on bounding area 104A and 104B to differentiate between predefined object 102A, predefined object 102B, and traversable space 106. Semantic segmentation corresponds to clustering parts of an image together which belong to the same object class. It is a form of pixel-level prediction where each pixel in an image is classified according to a category. For example, the original 2D image and processed image 100A are each comprised of a number of pixels which have different values associated with each pixel. Depending on changes between pixels that are arranged close to or next to each other (e.g., within one of bounding areas 104A or 104B), an object may be identified based on a comparison to a library of information characterizing objects with confidence or error factors (e.g., where pixel values and transitions do not exactly align, an object may still be identified based on a probability computation that the object in the image corresponds to an object in the library).

As shown in processed image 102B, the semantic segmentation performed groups pixels into object 102A, object 102B, and road 106. In some embodiments, background 108 may also be separated based on a modification of pixel tones such that objects 102A and 102B are a first tone or color, road 106 is a second tone or color, and background 108 is a third tone or color. Processed image 102B provides a means to differentiate between pixels in multiple images in order to assign values to each grouping of pixels in order to characterize the environment around the vehicle and objects within the environment. For example, by identifying background 108 and related pixels, subsequent images can have the background more readily identified which results in less data being considered for generating and transmitting instructions for various driver assist features. In some embodiments, processed image 102B may be generated for display and involves modifying one or more of the original 2D image or processed image 100A to differentiate between the objects and the road by incorporating one or more of a change in a color of pixels comprising one or more of the object or the traversable space or a label corresponding to a predefined classification of pixels comprising one or more of the object or the traversable space.

Processed image 100C corresponds to an initial generation of a 3D model of an environment comprised of objects 102A and 102B as well as traversable space 110 and non-traversable space 112. This initial generation of the 3D model is based on the semantic segmentation, and the 3D model corresponding to processed image 100C includes information useful for one or more of processing or transmitting instructions useable by one or more driver assistance features of the vehicle. For example, where processed image 100B identifies objects 102A and 102B as well as road 108, processed image 100C provides additional context to the pixels of the original 2D image by differentiating between non-traversable space 112 (e.g., which is occupied by object 102A) and traversable space 110 (e.g., which is not occupied by a vehicle). In some embodiments, traversable space 110 may be further defined by detected lane lines as would be present on a highway or other road. In some embodiments, processed image 100C is generated by modifying one or more of the original 2D image, processed image 100A, or processed image 100B to differentiate between one or more of object 102A, traversable space 110, or non-traversable space 112 by incorporating one or more of a change in a color of pixels comprising one or more of the object or the traversable space or a label corresponding to a predefined classification of pixels comprising one or more of the object or the traversable space. The modification may include the generation of a 3D bounding area around one or more of object 102A or traversable space 110 in order to identify which pixels correspond to non-traversable space 112 or other areas the vehicle cannot proceed (e.g., road-way barriers or other impeding structures). As shown in processed image 100C, the 3D bounding area can result in the modification of a display of one or more of the object or the traversable space to include one or more of a color-based demarcation or a text label.

Processed image 100D corresponds to the generation of a 3D model of an environment comprised of object 102A, object 102B, and assigned values 114A and 114B. Assigned values 114A and 114B values correspond to one or more of a heading, a depth within a three-dimensional space, or a regression value. These values aid in generating a more comprehensible 3D model as compared to processed images 100B and 100C as these values indicate current and expected movements of objects 102A and 102B. These values are significant for generating and transmitting various driver assist instructions (e.g., identifying whether the vehicle is at risk for overlapping trajectories or paths with objects 102A or 102B). Assigned values 114A and 114B may be generated for display as a label based on a 3D bounding area and may result in one or more of a color-based demarcation or text label (e.g., to differentiate between objects and assign respective values to each object). Where assigned values 114A and 114B correspond to regression values, the regression values may signify an amount of change in the pixels comprising the objects through the original 2D image along different axis or an amount of change in the pixels between 2D images in order to between characterize one or more of an object location, an object trajectory, or an object speed for each respective object. In some embodiments, processed image 100D may be generated based on one or more of the original 2D image or processed images 100A-100C. Processed image 100D may also be generated for display to allow a driver of the vehicle to track objects regularly around the vehicle being driven by the driver as the driver progresses down a road or along a route.

It will be understood images 100A-D may be generated and stored in various data formats. It will also be understood that images 100A-D may not be generated for display. As an example, image 100A may be represented in memory by the vertices of bounding areas 104A and 104B, where a displayable image containing bounding areas 104A and 104B is not generated.

FIG. 2 depicts object detection scenario 200 where vehicle 202 is configured to capture one or more 2D images of an environment around vehicle 202 to generate a 3D model of the environment around vehicle 202, in accordance with some embodiments of the disclosure. Scenario 200 may result in the generation of one or more of processed images 100A-100D of FIG. 1, may use one or more of monocular camera 300 of FIG. 3 (e.g., arranged about or affixed to vehicle 202 in one or more positions on or around vehicle 202), may incorporate process 400 of FIG. 4, may incorporate process 500 of FIG. 5, may utilize object detection corresponding to FIG. 6, may incorporate process 700 of FIG. 7, may incorporate one or more components of vehicle system 800 of FIG. 8 into vehicle 202, or may result in the generation for display of one or more of processed images 100A-100D as shown in FIG. 9.

Scenario 200 depicts vehicle 202 traversing along path 204 as defined by lane lines 206. Vehicle 202 includes sensors 210 arranged to collect data and characterize the environment around vehicle 202. Sensors 210 may each be one or more of a monocular camera, a sonar sensor, a lidar sensor, or any suitable sensor configured to characterize an environment around vehicle 202 in order to generate at least one 2D image for processing to generate a 3D model of the environment around vehicle 202. The environment around vehicle 202 is comprised of barrier 208, object 102A of FIG. 1 and object 102B of FIG. 1. Objects 102A and 102B are shown as traversing along a lane parallel to the lane defined by lane lines 206 and are captured by one or more of sensors 210. Each of sensors 210 has respective fields of view 212. Fields of view 212 may be defined based on one or more of a lens type or size of cameras corresponds to each of sensors 210, an articulation range of each of sensors 210 along different axes (e.g., based on adjustable mounts along different angles), or other means of increasing or decreasing the fields of view of each of sensors 210.

As shown in FIG. 2, fields of view 212 may not overlap. In some embodiments, fields of view may partially overlap resulting in an exchange of information from each 2D image captured in order to between character objects 102A and 102B. For example, object 102A is within a pair of fields of view 212 of two of sensors 210 arranged along a side of vehicle 202. Processing of an image captured by a first of sensors 210 may improve object detection and 3D model information being generated in response to processing of a second image captured by a second of sensors 210. For example, object 102A may be depicted at a first angle in a first image and may be depicted at a second angle in a second image. Each of the first image and the second image may be processed such that respective bounding areas around object 102A are generated in each respective image. Therefore, the bounding area in the first image is a first bounding area while the bounding area in the second image is a second bounding area. The second bounding area may be generated based on data taken from the first image via the first bounding area (e.g., as shown in processed image 100A of FIG. 1). Data corresponding to pixels within the first bounding area is compared to data within the second bounding area (e.g., via processing which may result in semantic segmentation of each image). The data within the first bounding area may be considered object characterization data, which is discussed in more detail in reference to FIG. 6. The second bounding area (e.g., in the second image captured by the second of sensors 210) is generated based on the object characterization data.

FIG. 3 depicts monocular camera 300 with different ranges of views along different orientations for capturing 2D images, in accordance with some embodiments of the disclosure. Monocular camera 300 may be fixedly attached and unable to articulate about different orientations or rotational axes. Monocular camera 300 may also be utilized to capture a 2D image used for generating one or more of processed images 100A-100D of FIG. 1, in object detection scenario 200 of FIG. 2, for process 400 of FIG. 4, for process 500 of FIG. 5, for object detection corresponding to FIG. 6, for process 700 of FIG. 7, in combination with one or more components of vehicle system 800 of FIG. 8, or may capture the 2D image for generation on a display of one or more of processed images 100A-100D, as shown in FIG. 9.

Monocular camera 300 corresponds to one or more of sensors 210 of FIG. 2 and may be utilized to capture a 2D image for generating one or more of processed images 100A-100D. As shown in FIG. 3, monocular camera 300 has three axes of movement. Axis 302 corresponds to a yaw angle range of motion. The yaw angle range of motion corresponds to rotational motion about axis 302 based on a direction in which lens 308 of monocular camera 302 is pointing. The yaw angle range may be zero where monocular camera 300 is fixed along axis 302 or may be up to 360 degrees where monocular camera 300 is arranged and configured to rotate completely about axis 302. Depending on which part of a vehicle (e.g., vehicle 202 of FIG. 2) monocular camera 300 is mounted to, the ideal yaw angle range about axis 302 may be 45 degrees from a center point (e.g., +/−45 degrees from an angle valued at 0). Axis 304 corresponds to a pitch angle range of motion. The pitch angle range of motion corresponds to rotation of monocular camera 300 about axis 304 such that lens 308 is able to move vertically up and down based on a rotation of the main body of monocular camera 300. The range about axis 304 which monocular camera 300 may rotate may be the same as or less than the range about axis 302 monocular camera 300 may rotate, depending on which part of a vehicle monocular camera 300 is mounted. Axis 306 corresponds to a roll angle range of motion. The roll angle range of motion corresponds to rotation of one or more of lens 308 or monocular camera 300 about axis 306 such that the angle of a centerline of lens 308 or monocular camera 300 changes relative to a level surface or horizontal reference plane (e.g., the horizon appearing in a background of an image). The range about axis 306 which monocular camera 300 or lens 308 may rotate may be the same as or less than the range about axis 302 monocular camera 300 may rotate, depending on which part of a vehicle monocular camera 300 is mounted. The axes and ranges described in reference to monocular camera 300 may be applied to any or all of sensors 210 of FIG. 2. In some embodiments, monocular camera 300 may be combined with or replaced by one or more of sonar sensors, lidar sensors, or any suitable sensor for generating a 2D image of an environment around the vehicle or any suitable sensor for collecting data corresponding to an environment surrounding the vehicle (e.g., vehicle 202 of FIG. 2).

FIG. 4 depicts process 400 for processing 2D image 402 to identify object 404 near a vehicle (e.g., a vehicle having a monocular camera configured to capture a 2D image of objects and an environment around the vehicle), in accordance with some embodiments of the disclosure. Process 400 may result in one or more of the generation of one or more of processed images 100A-100D of FIG. 1, the progression of object detection scenario 200 of FIG. 2, may utilize monocular camera 300 of FIG. 3, the execution of process 500 of FIG. 5, the use of object detection corresponding to FIG. 6, the execution of process 700 of FIG. 7, utilizing one or more components of vehicle system 800 of FIG. 8, or generating for display one or more of processed images 100A-100D, as shown in FIG. 9.

Process 400 is based on a 2D detection head (e.g., a sensor configured to capture 2D image 402 such as monocular camera 300 of FIG. 3) interfacing with a multi-task network comprised of common backbone network 404, common neck network 406, semantic head 408, and detection head 410. The multi-task network depicted via process 400 enables the inclusion of one or more of a depth head (e.g. for determining how far away a detected object is from a vehicle based on processing of a 2D image), an orientation head (e.g. for determining a direction or a heading of a detected object relative to the vehicle based on processing of a 2D image), free space detection (e.g. for determining where the vehicle can safely traverse based on processing of a 2D image), visually embedding object tracking (e.g., assigning text, graphics, or numerical values to a detected object for consistent tracking between images or while a sensor continues to collect data on a detected object), or additional detection heads (e.g., one or more of multiple cameras or multiple sensors collecting additional data for improving confidence in object detection and object characterization within the environment around the vehicle). In some embodiments, the multi-task network used to execute process 400 may include more or fewer than the elements shown in FIG. 4 (e.g., depending on the complexity of a vehicle and accompanying networks configured to generate a 3D model of an environment around the vehicle using 2D images). One or more of common backbone network 404, common neck network 406, semantic head 408, or detection head 410 may be incorporated into a single module or arrangement of processing circuitry or may be divided among multiple modules or arrangements of processing circuitry. Each step of process 400 may be achieved contemporaneously or progressively, depending on one or more of the configuration of the multi-head network, the arrangement of the different elements, the processing power associated with each element, or a network capability of a network connecting each element of the depicted multi-head network used to execute one or more aspects of process 400.

Process 400 starts with 2D image 402 being captured based on data acquired via one or more sensors on a vehicle. 2D image 402 is provided to common backbone network 404. Common backbone network 404 is configured to extract features from 2D image 402 in order to differentiate pixels of 2D image 402. This enables common backbone network 404 to group features and related pixels of 2D image 402 for the purposes of object detection and traversable space detection (e.g., as described in reference to the processed images of FIG. 1). Common backbone network 404 may be communicably coupled to one or more libraries with data stored that provides characterizations of objects based on pixel values (e.g., one or more of color values or regression values indicating differences between pixels within a group). Common backbone network 404 may also be configured to accept training based on the detection of objects that fail to be matched with objects in the library and may activate additional sensors with additional libraries for adequately characterizing the object. In some embodiments, common backbone network 404 may provide a means for configuring one or more of a fully connected neural network (e.g., where object detection is based on searching connected databases or libraries for matches), a convolutional neural network (e.g., a network configured to classify images based on comparisons and iterative learning based on corrective error factors), or a recurrent neural network (e.g., where object detection is iteratively improved based on errors detected in a previous processing cycle that are factored into confidence factors for a subsequent processing of an image to detect the same or other objects).

Common backbone network 404 is shown as first processing 2D image 402 into n-blocks 412 for grouping pixels of 2D image 402. N-blocks 412 may be defined by Haar-like features (e.g., blocks or shapes to iteratively group collections of pixels in 2D image 402). N-blocks 412 are then grouped into block groups 414, where each block group is comprised of blocks of 2D image 402 with at least one related pixel value. For example, where 2D image 402 includes a pickup truck and a road, all blocks of n-block 412 related to a surface of the truck may be processed in parallel or separately from all blocks of n-blocks 412 related to a surface of the road. Block groups 414 are then transmitted to common neck network 406. Common neck network 406 is configured to differentiate between the different aspects of block groups 414 such that, for example, each of block groups 414 associated with an object (e.g., the truck) are processed separately from each of block groups 414 associated with a traversable space (e.g., the road) and results in pixel group stack 416. Pixel group stack 416 allows for grouping of pixels based on their respective locations within 2D image 402 and provides defined groupings of pixels for processing by semantic head 408 as well as detection head 410.

Common neck network 406 is configured to transmit pixel group stack 416 to both semantic head 408 and detection head 410, as shown in FIG. 4. In some embodiments, the transmission of pixel group stack 416 occur simultaneously to both semantic head 408 and detection head 410 (e.g., for simultaneous generation of processed images 100A-D of FIG. 1) or progressively (e.g., for progressive generation of processed images 100A-D of FIG. 1). Semantic head 408 is configured to perform deconvolution of pixel group stack 416. Deconvolution, in the context of this application, is the spreading of information or data associated with a pixel of pixel group stack 416 to multiple pixels, thereby defining groupings of pixels from a convoluted image corresponding to pixel group stack 416 as portions of original 2D image 402. This enables semantic head 408 to generate processed image 100B of FIG. 1, where pixels comprising object 102A are differentiated from pixels comprising road 106. As shown in FIG. 4, deconvolution may occur in multiple steps, depending on how complex 2D image 402 is. In some embodiments, deconvolution may occur in a single step based on a single scale, where object detection is readily performed based on clear differentiation of pixels.

Detection head 410 is configured to perform convolution of pixel group stack 416. Convolution, in the context of this application, is the process of adding information spread across a number of pixels into various pixels. As shown in FIG. 4, convolution may occur in two manners. Convolution as performed by detection head 410 may be used to generate processed image 100A, where object 102A is depicted as being defined within bounding area 104A. Additionally, convolution may also be used to generate processed image 100D, wherein object 102A is labelled with assigned values 114A. Detection head 410 uses convolution to group pixels of 2D image 402 such that one or more of bounding areas, labels, or values may be generated for display as part of the 3D model generation on a display for driver interpretation (e.g., as shown in FIG. 9). In some embodiments, the generation of processed image 100A may be used with non-max suppression to assist in the generation of processed image 100D. Non-max suppression involves selecting a bounding area out of a number of bounding areas created during the generation of processed image 100A, where the bounding area is associated with a region of object 102A where assigned valued 114A may be arranged when processed image 100D is generated for display (e.g., the suppression may result in the arrangement of assigned values 114A towards a center point of object 102A). In some embodiments, one or more of semantic head 408 or detection head 410 may be used to generate processed image 100C of FIG. 1. For example, processed image 100B may be used to generate processed image 100C which is then provided to detection head 410 for improving the accuracy of the arrangement of assigned values 114A.

In some embodiments, a heading and coordinate system corresponding to object 102A as detected in 2D image 402 is developed to predict start and end coordinates of object 102A within 2D image 402, which is used to develop a coordinate and vector for the object within a 3D model. For example, maximum and minimum coordinates along multiple axes as defined by the framing of 2D image 402 may be extracted or determined based on different pixel analysis resulting in x and y coordinates with maximum and minimum values within a space corresponding to the area captured in 2D image 402. A radial depth of object 102A and the yaw of object 102A (e.g., how the object is oriented to the vehicle or how the vehicle is oriented to the object) with respect to the camera (e.g., camera 300 of FIG. 3 or one or more of sensors 210 of FIG. 2) and height of object 102A may also be determined based on an analysis of the various pixels comprising object 102A within 2D image 402. One or more of the coordinate values, the radial depth, the yaw or other information determined based on processing of 2D image 402 may be refined using a confidence value predicted for each parameter described above along with a variance predictor (e.g., as described in reference to FIG. 6 where additional data may be transmitted or received to improve a characterization of object 102A). Based on the extracted or determined information, in addition to improvements in confidence values based on variance predictions, the 2D version of object 102A can be converted to a 3D version of object 102A that interacts within a 3D environment surrounding the vehicle. For example, a 3D centroid of the object within a 2D image plane may be predicted and projected into a 3D model such that the object is identified as a solid item that should be avoided.

FIG. 5 depicts a block diagram of process 500 for generating a 3D model based on a 2D image, in accordance with some embodiments of the disclosure. Process 500 may result in one or more of the generation of one or more of processed images 100A-100D of FIG. 1, may be used as object detection scenario 200 of FIG. 2 progresses, may result in the use of monocular camera 300 of FIG. 3, may incorporate one or more elements of process 400 of FIG. 4, may be executed in response to the object detection characterized via FIG. 6, may incorporate one or more elements of process 700 of FIG. 7, may be executed using one or more components of vehicle system 800 of FIG. 8, or may result in the generation for display of one or more of processed images 100A-100D, as shown in FIG. 9.

At 502, a two-dimensional image (hereinafter “2D image”) is captured using one or more sensors of a vehicle. For example, the sensors may be monocular camera 300 of FIG. 3 and arranged on vehicle 202 of FIG. 2. If it is determined (e.g., using processing circuitry configured to execute one or more steps of process 400 of FIG. 4) that there is not an object in the 2D image (NO at 504), process 500 ends. If it is determined there is an object in the 2D image (YES at 504), then a bounding area is generated at 506. The bounding area is generated around the object detected in the 2D image (e.g., as shown in processed image 100A of FIG. 1). Once the bounding area is generated, the pixels within the bounding area are processed to determine if the object satisfies confidence criteria as shown in FIG. 6 to determine of the object is a known object. If the object does not satisfy confidence criteria based on data accessible by a vehicle network (NO at 508), then data is accessed at 510 from one or more of at least one additional sensor (e.g., a second camera or a sensor of a different type arranged to characterize objects within the area around the vehicle corresponding to the 2D image) or at least one server (e.g., a library or data structure with additional data for confirming whether pixels in an image form an object that is either on the vehicle or communicatively accessible via the vehicle) to improve confidence of object detection within the 2D image. If the object does satisfy confidence criteria based on data accessible by a vehicle network (YES at 508), then semantic segmentation of the 2D image is performed at 512 based on the bounding area to differentiate between the object and a traversable space for the vehicle (e.g., as shown in processed image 100B of FIG. 1). At 514, a three-dimension model (hereinafter “3D model”) of an environment comprised of the object and the traversable space is generated based on the semantic segmentation (e.g., as depicted in processed images 100C and 100D). The 3D model may be generated by one or more elements of a vehicle network depicted in and described in reference to FIG. 4. Generating the 3D model may include one or more of creating one or more data structures comprised of instructions and related data for orientating or processing the data stored in the one or more data structures (e.g., vertices of 3D shapes based on a vehicle centroid and other data processed from or extracted from the 2D image), transmitting and storing data corresponding to the 3D model in one or more processors, or processing data corresponding to the 3D model for one or more outputs perceivable by a driver. At 516, the 3D model is used for one or more of processing or transmitting instructions usable by one or more driver assistance features of the vehicle (e.g., to prevent an impact between the vehicle and an object by planning a route of the vehicle to avoid the object and proceed unimpeded through the traversable space).

FIG. 6 depicts 2D images 600A and 600B processed based on a comparison to confidence factor table 600C to train a neural network of a vehicle for subsequent object detection, in accordance with some embodiments of the disclosure. Each of 2D image 600A, 2D image 600B, and confidence factor table 600C may be utilized during generation of one or more of processed images 100A-100D of FIG. 1, may be utilized based on the progression of object detection scenario 200 of FIG. 2, may be generated using monocular camera 300 of FIG. 3, may result in the progression of process 400 of FIG. 4, may result in the progression of process 500 of FIG. 5, may result in the progression of process 700 of FIG. 7, may be used with one or more components of vehicle system 800 of FIG. 8, or may be used as part of the generation for display of one or more of processed images 100A-100D, as shown in FIG. 9.

2D image 600A and 2D image 600B may be captured by a monocular camera (e.g., monocular camera 300 of FIG. 3) or any other suitable sensor (e.g., one or more of sensors 210 of FIG. 2). Both of these images may processed according to process 400 to identify one or more objects in each image. For example, 2D image 600A includes a front view of a vehicle while image 600B includes an angle view of the same vehicle. These two images may be captured as the depicted vehicle approaches a vehicle from the rear and the pulls up alongside (e.g., as would occur on a road with multiple lanes). Bounding areas 602A and 602B are generated around each vehicle in each of 2D image 600A and 2D image 600B and each vehicle (e.g., objected) is compared to predefined objects stored in memory, as exemplified by confidence factor table 600C. A predefined object library may be stored on vehicle or may be accessible by the vehicle based on various communication channels. In some embodiments, each of 2D image 600A and 2D image 600B includes an image clear enough for the confidence factor to be high enough (e.g., on a scale of 0.0 to 1.0, the confidence factor exceeds 0.9) to determine one or both images includes a pickup truck, as shown in confidence factor table 600C.

In some embodiments, a first image, such as 2D image 600A fails to generate a confidence factor exceeding a threshold (e.g., is less than 0.9) and a second image, such as 2D image 600B, is used to improve the confidence factor that the object detected in one or both of 2D image 600A and 2D image 600B is a pickup truck. The predefined objects used for generating the confidence factor may include one or more of a vehicle, a pedestrian, a structure, a driving lane indicator, or a solid object impeding travel along a trajectory from a current vehicle position. As shown in confidence factor table 600C, the object detection may be so clear as to provide a confidence factor of 1.0 for particular predefined objects where other instances of object detection may yield confidence factors below a threshold (e.g., 0.9) causing a vehicle system to pull additional data to improve confidence in the object detection.

In some embodiments, pixels defined by a first bounding (e.g., bounding area 602A) may be used generate at least part of a second bounding area (e.g., bounding area 602B). The first bounding area, or bounding area 602A, is generated around the object captured by the first monocular camera and data corresponding to pixels within the first bounding area is processed to generate object characterization data. The object characterization area may include one or more of a regression value, a color, or other value to characterize the pixels within the first bounding area. The second bounding area is then generated around an object identified in the second two-dimensional image captured by a second monocular camera based on the object characterization data. For example, bounding area 602A shows a front fascia of a vehicle which is then included in bounding area 602B. By including additional pixels in bounding area 602B beyond the front fascia, the confidence factor shown in confidence factor table 600C increases. Where the confidence factor meets or exceeds a threshold (e.g., 0.9), object detection algorithms and processes (e.g., as shown in FIG. 4) may be updated to improve confidence that a pickup truck was detected in future images similar to 2D image 600A without needing to capture 2D image 600B. For example, confidence factor table 600C may be updated to increase the confidence factors related to “Pickup Truck” where only 2D image 600A or similar images are captured for subsequent processing. Additionally, or alternatively, a vehicle system may be configured to reduce compiling of data or prevent activation of additional vehicle sensors when an image similar to or related to 2D image 600A is captured. In some embodiments, where the confidence factor as pulled from confidence factor table 600C is below a threshold (e.g., 0.9), additional sensors may be activated for additional object characterization (e.g., to improve training of the vehicle with respect to object detection in 2D images).

FIG. 7 depicts a block diagram of process 700 for updating a method of processing of data to generate a 3D model based on a 2D image, in accordance with some embodiments of the disclosure. Process 700 may be utilized, in whole or in part, to generate one or more of processed images 100A-100D of FIG. 1, for object detection scenario 200 of FIG. 2, may be executed using monocular camera 300 of FIG. 3, may incorporate one or more elements of process 400 of FIG. 4, may incorporate one or more elements of process 500 of FIG. 5, may utilize object detection corresponding to FIG. 6, may be executed using one or more components of vehicle system 800 of FIG. 8, or may result in the generation for display of one or more of processed images 100A-100D, as shown in FIG. 9.

At 702, a first two-dimensional image (hereinafter “first 2D image”) is captured using one or more sensors of a vehicle (e.g., one or more of monocular camera 300 of FIG. 3). At 704, an object is detected in the first 2D image based on semantic segmentation of the first 2D image (e.g., as described in reference to FIGS. 1 and 4). At 706, the object is compared to one or more predefined objects (e.g., as described in reference to FIG. 6). At 708, a confidence factor is determined corresponding to a likelihood that object corresponds to one or more of the predefined objects (e.g., the confidence factor may be pulled from a table as shown in FIG. 6 or may be computed while the first 2D image is processed by one or more heads described in reference to FIG. 4). The confidence factor is compared to a threshold and if it is determined that the confidence factor meets or exceeds a threshold value for the confidence factor (YES at 710), then a bounding area is generated at 712 in the first 2D image based on the predefined object. If it is determined that the confidence factor does not meet or exceed the threshold value for the confidence factor (NO at 710), then a first bounding area is generated at 714 around the object in the first 2D image. At 716, data correspond to pixels within the first bounding area are processed to generate object characterization data (e.g., one or more of color values or regression values for each pixel within the first bounding area). At 718, a second two-dimensional image (hereinafter “second 2D image’) with the object is captured. The second 2D image may be captured by a same sensor or a different sensor as was used to capture the first 2D image. At 720, a second bounding area is generated around the object identified in the second 2D image based on the object characterization data (e.g., as shown in FIG. 6).

FIG. 8 depicts vehicle system 800 configured to generate a 3D model based on a 2D image, in accordance with some embodiments of the disclosure. Vehicle system 800 may be configured to generate one or more of processed images 100A-100D of FIG. 1, may be utilized to executed object detection scenario 200 of FIG. 2, may incorporate monocular camera 300 of FIG. 3, may be configured to execute process 400 of FIG. 4, may be configured to execute process 500 of FIG. 5, may utilize the object detection corresponding to FIG. 6, may be configured to execute process 700 of FIG. 7, or may be configured to generate one or more of processed images 100A-100D, as shown in FIG. 9.

Vehicle system 800 is comprised of vehicle assembly 802, server 810, mobile device 812, and accessory 814. Vehicle assembly 802 corresponds to vehicle 202 of FIG. 2 and is configured to execute one or more methods of the present disclosure. Vehicle assembly 802 is comprised of vehicle body 804. Arranged within vehicle body 804 are processing circuitry 806 and sensor 808. Processing circuitry 806 may be configured to execute instructions corresponding to a non-transitory computer readable medium which incorporates instructions inclusive of one or more elements of one or more methods of the present disclosure. Communicatively coupled to processing circuitry is sensor 808. Processing circuitry 806 may comprise one or more processors arranged throughout vehicle body 804, either as individual processors or as part of a modular assembly (e.g., a module configured to transmit automated driving instructions to various components communicatively coupled on a vehicle network). Each processor in processing circuitry 806 may be communicatively coupled by a vehicle communication network configured to transmit data between modules or processors of vehicle assembly 802. Sensor 808 may comprise a single sensor or an arrangement of a plurality of sensors. In some embodiments, sensor 808 corresponds to monocular camera 300 of FIG. 3 or may be one or more of the sensors described in reference to sensors 210 of FIG. 2. Sensor 808 is configured to capture data related to one or more 2D images of an object near vehicle assembly 802 and an environment around vehicle assembly 802. Processing circuitry 806 is configured to process data from the 2D image captured via sensor 808 along with data retrieved via one or more of server 810, mobile device 812, or accessory 814. The data retrieved may include any data that improves confidence scores associated with individual objects in the 2D image. In some embodiments, one or more aspects of the data retrieved may be from local memory (e.g., a processor within vehicle assembly 802). Accessory 814 may be a separate sensor configured to provide additional data for improving accuracy or confidence in object detection and 3D model generation performed at least in part by processing circuitry 806 (e.g., in a manner that a second image is used in FIGS. 6 and 7). Mobile device 812 may be a user device communicatively coupled to processing circuitry 806 enabling a redundant or alternative connection for vehicle assembly 802 to one or more of server 810 or accessory 814. Mobile device 812 may also relay or provide data to processing circuitry for increased confidence in object detection or other related data for improving instructions transmitted for various driver assist features enables via processing circuitry 806. For example, the generated 3D model may include relative location and trajectory data between the vehicle and various objects around the vehicle. Additional data from sensors on a same network or accessible by the vehicle (e.g., additional camera views from neighboring vehicles on a shared network or additional environment characterization data from various monitoring networks corresponding to traffic in a particular area).

FIG. 9 depicts vehicle displays 900A and 900B in vehicle interior 902 that each generate a 3D model for display, in accordance with some embodiments of the disclosure. Each of vehicle displays 900A and 900B may be generated based on one or more of processed images 100A-100D of FIG. 1, using object detection scenario 200 of FIG. 2, using monocular camera 300 of FIG. 3, using process 400 of FIG. 4, using process 500 of FIG. 5, using object detection corresponding to FIG. 6, using process 700 of FIG. 7, or using one or more components of vehicle system 800 of FIG. 8.

Vehicle display 900A corresponds to a display behind a steering wheel on a vehicle dashboard (e.g., vehicle 202 of FIG. 2). Vehicle display 900A may be configured to display one or more of processed images 100A-100D or, as depicted in FIG. 9, may be configured to display an overhead view of the 3D model generated while generating processed images 100A-100D. The overhead view includes road barrier 902, vehicle body 904, object 906, and lane lines 908. One or more of these elements may be characterized from data used to generate one or more of processed images 100A-100D. Vehicle display 900B corresponds to a center console dashboard display of the vehicle. Vehicle display 900B may be configured to display each of processed images 100A-100D, as shown in FIG. 9. In some embodiments, vehicle display 900B may only show one of processed images 100A-100D (e.g., based on user display settings). Additionally, the overhead view shown in vehicle display 900A may also be generated for display on vehicle display 900B.

The systems and processes discussed above are intended to be illustrative and not limiting. One skilled in the art would appreciate that the actions of the processes discussed herein may be omitted, modified, combined, and/or rearranged, and any additional actions may be performed without departing from the scope of the invention. More generally, the above disclosure is meant to be exemplary and not limiting. Only the claims that follow are meant to set bounds as to what the present disclosure includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

While some portions of this disclosure may refer to “convention” or examples, any such reference is merely to provide context to the instant disclosure and does not form any admission as to what constitutes the state of the art.

What is claimed is:

1. A method comprising:
generating a bounding area around an object identified in a two-dimensional image captured by one or more sensors of a vehicle;
performing semantic segmentation of the two-dimensional image based on the bounding area to differentiate between the object and a traversable space; and
generating a three-dimensional model of an environment comprised of the object and the traversable space based on the semantic segmentation, wherein the three-dimensional model is used for one or more of processing or transmitting instructions useable by one or more driver assistance features of the vehicle.

2. The method of claim 1, wherein the two-dimensional image is captured by a monocular camera.

3. The method of claim 1, further comprising:
modifying the two-dimensional image to differentiate between the object and the traversable space by incorporating one or more of a change in a color of pixels comprising one or more of the object or the traversable space or a label corresponding to a predefined classification of pixels comprising one or more of the object or the traversable space; and
assigning values to pixels corresponding to the object, wherein the values correspond to one or more of a heading, a depth within a three-dimensional space, or a regression value.

4. The method of claim 1, further comprising generating for display the three-dimensional model.

5. The method of claim 1, wherein the three-dimensional model comprises a three-dimensional bounding area around one or more of the object or the traversable space.

6. The method of claim 5, wherein the three-dimensional bounding area modifies a display of one or more of the object or the traversable space to include one or more of a color-based demarcation or a text label.

7. The method of claim 1, wherein the bounding area is generated in response to identifying a predefined object in the two-dimensional image.

8. The method of claim 7, wherein the predefined object is one of a vehicle, a pedestrian, a structure, a driving lane indicator, or a solid object impeding travel along a trajectory from a current vehicle position.

9. The method of claim 1, wherein the three-dimensional model comprises a characterization of movement of the object relative to the vehicle and the traversable space based on one or more values assigned to pixels corresponding to the object in the two-dimensional image, wherein the one or more values correspond to one or more of a heading, a depth within a three-dimensional space around the vehicle, or a regression value.

10. The method of claim 1, wherein the bounding area is a second bounding area, wherein the two-dimensional image is a second two-dimensional image, and wherein generating the second bounding area comprises:
generating a first bounding area around an object for a first two-dimensional image captured by a first monocular camera;
processing data corresponding to pixels within the first bounding area to generate object characterization data; and
generating the second bounding area around an object identified in the second two-dimensional image captured by a second monocular camera based on the object characterization data.

11. A system comprising:
a monocular camera;
processing circuitry, communicatively coupled to the monocular camera, configured to:
generate a bounding area around an object identified in a two-dimensional image captured by one or more sensors of a vehicle;
perform semantic segmentation of the two-dimensional image based on the bounding area to differentiate between the object and a traversable space; and
generate a three-dimensional model of an environment comprised of the object and the traversable space based on the semantic segmentation, wherein the three-dimensional model is used for one or more of processing or transmitting instructions useable by one or more driver assistance features of the vehicle.

12. The system of claim 11, wherein the two-dimensional image is captured by the monocular camera.

13. The system of claim 11, wherein the processing circuitry is further configured to:
modify the two-dimensional image to visually differentiate between the object and the traversable space by incorporating one or more of a change in a color of pixels comprising one or more of the object or the traversable space or a label corresponding to a predefined classification of pixels comprising one or more of the object or the traversable space; and
assign values to pixels corresponding to the object, wherein the values correspond to one or more of a heading, a depth within a three-dimensional space, or a regression value.

14. The system of claim 11, further comprising a display, wherein the processing circuitry is further configured to modify an output of the display with one or more elements of the three-dimensional model.

15. The system of claim 11, wherein the processing circuitry configured to generate the three-dimensional model is further configured to generate a three-dimensional bounding area around one or more of the object or the traversable space.

16. The system of claim 15, wherein the three-dimensional bounding area modifies a display of one or more of the object or the traversable space to include one or more of a color-based demarcation or a text label.

17. The system of claim 11, wherein the processing circuitry is further configured to:
identify one or more objects in the two-dimensional image;
compare the one or more objects to predefined objects stored in memory;
identify the one or more objects as respective predefined objects; and
in response to identifying the one or more objects as the respective predefined objects, generate one or more respective bounding areas around the respective predefined objects.

18. The system of claim 17, wherein each of the respective predefined objects is one of a vehicle, a pedestrian, a structure, a driving lane indicator, or a solid object impeding travel along a trajectory from a current vehicle position.

19. The system of claim 11, wherein the three-dimensional model comprises a characterization of movement of the object relative to the vehicle and the traversable space based on one or more values assigned to pixels corresponding to the object in the two-dimensional image, wherein the one or more values correspond to one or more of a heading, a depth within a three-dimensional space around the vehicle, or a regression value.

20. A non-transitory computer readable medium comprising computer readable instructions which, when processed by processing circuitry, cause the processing circuitry to:
generate a bounding area around an object identified in a two-dimensional image captured by one or more sensors of a vehicle;
perform semantic segmentation of the two-dimensional image based on the bounding area to differentiate between the object and a traversable space; and
generate a three-dimensional model of an environment comprised of the object and the traversable space based on the semantic segmentation, wherein the three-dimensional model is used for one or more of processing or transmitting instructions useable by one or more driver assistance features of the vehicle.
